(19) United States
(12) Patent Application Publication
(10) Pub. No.: US 2019/0049355 A1
(43) Pub. Date: Feb. 14, 2019

(54) Method and Sensor System for Detecting Particles

(71) Applicant: ams AG, Premstäetten (AT)

(72) Inventor: Jan Enenkel, GRATKORN (AT)

(21) Appl. No.: 16/087,295

(22) PCT Filed: Mar. 24, 2017
(86) PCT No.: PCT/EP2017/057072

§ 371 Date: Sep. 21, 2018

(30) Foreign Application Priority Data
Mar. 31, 2016 (EP) 16163391.2

(51) Int. Cl. G01N 15/06

(52) U.S. Cl. CPC G01N 15/06; G01N 2015/0046; G01N 2015/0687; G01N 2015/0693

(57) ABSTRACT

A method for detecting particles comprises emitting by an emitter unit a first pulse of light into a measurement chamber in a specified emission direction, detecting first reflected fractions by a photosensitive element during a first time window and determining an amount of particles depending on the detection of the first reflected fractions. A path with minimum length for a light ray being emitted by the emitter unit, reflected from a reflector and detected by the photosensitive element is defined by the emission direction and by a mutual arrangement of the reflector, the emitter unit and the photosensitive element. A difference between a starting time of the first pulse and an end time of the first time window is smaller than a time-of-flight for light propagating along the path with minimum length.

The invention relates to the field of detecting or sensing particles. More precisely, the invention relates to a method and a sensor system for detecting, in particular optically detecting, particles, in particular particles in a medium, for example air or a liquid such as water, present in a measurement chamber.

### BACKGROUND OF THE INVENTION

Existing approaches for detecting particles may use a system with an LED and a conventional photodiode within a measurement chamber filled with a medium such as air. For example, depending on the amount of particles in the medium, more or less light emitted by the LED is scattered by the particles and received by the photodiode.

A drawback of such approaches is that dirt, particles, contamination and/or dust may adhere on interior surfaces of the measurement chamber and on surfaces of optical elements like the LED or the photodiode, in particular molds, housings or covers thereof, or lenses. This accumulation of contamination may for example be even enhanced by air humidity.

Consequently, a signal representing the measured amount of particles in the medium may get tampered for example by light absorption due to the contamination on the optical elements and/or the measurement chamber, which may lead to a reduced measurement accuracy. As the described contamination may get worse during lifetime, the sensor system may lack longtime reliability.

### SUMMARY OF THE INVENTION

Herein, particles may for example comprise dust particles, particulates, smoke particles, biological particles or other types of particles. The particle sizes may for example lie in the range of nanometers, micrometers and/or millimeters. Typical particle sizes may include 100 nm, 1 μm, 2.5 μm or 10 μm.

Herein, the expression “air” generally denotes a gas or a gaseous mixture, for example present in an environment of a sensor system according to the improved concept. In particular, “air” may denote a gaseous mixture as present in the atmosphere of the earth. However, the expression “air” should not be understood in a limiting sense regarding a particular composition of the gas or gaseous mixture. In particular, the implementations according to the improved concept do not rely on such a particular composition.

Herein, the expression “light” generally denotes electromagnetic radiation with a wavelength within a visible, infrared and/or ultraviolet spectrum of radiation.

According to the improved concept, a first pulse of light is emitted into a measurement chamber by an emitter unit and first fractions of the first pulse being reflected by particles in a medium present in the measurement chamber are detected by a photosensitive element during a first time window. Therein, the first time window is specifically adjusted to a timing of the first pulse and to a mutual arrangement of the measurement chamber, the emitter unit and the photosensitive element. In particular, the first measurement window ends before a point in time when light being reflected from the measurement chamber, for example a reflector of the measurement chamber, could hit the photosensitive element.

According to the improved concept, a method for detecting particles in a medium present in a measurement chamber is provided. The method comprises emitting by an emitter unit a first pulse of light into the measurement chamber, wherein the first pulse is emitted in a specified emission direction of the emitter unit. First reflected fractions of the first pulse, in particular reflected from particles in the medium, are detected by a photosensitive element during a first time window. The method further comprises determining, for example by means of a processing unit, an amount of particles in the medium depending on the detection of the first reflected fractions during the first time window. A particle measurement signal may for example be generated based on the determined amount of particles in the medium.

A path with minimum length for a light ray being emitted by the emitter unit, in particular in the emission direction, being subsequently reflected from a reflector of the measurement chamber and being detected by the photosensitive element is defined by the emission direction and by a mutual arrangement of the reflector, the emitter unit and the photosensitive element. The mutual arrangement may for example include orientations of the reflector, the emitter unit and/or the photosensitive element.

A difference between a starting time of the first pulse and an end time of the first time window is smaller than a time-of-flight, TOF, for light propagating along the path with minimum length.

Consequently, the first reflected fractions of light detected during the first time window are not subject to reflections from the measurement chamber, in particular the reflector, and are therefore not subject to absorption by contamination of the measurement chamber, in particular the reflector. Therefore, an accuracy of the determined amount of particles in the medium may be increased. Furthermore, a longtime reliability of a sensor system using a method according to the improved concept may be increased.

In case a plurality of paths for a light ray being emitted by the emitter unit, reflected from the reflector and detected by the photosensitive element with different path lengths exist, the path with minimum length corresponds to one of the plurality of paths having a minimum path length.

It is pointed out that the light ray mentioned for specifying the path with minimum length is for example a virtual or imagined light ray that is not necessarily actually emitted by the emitter unit. Said light ray does for example not include any reflections except reflections from the reflector, in particular it does not include any reflections from particles in the medium within the measurement chamber.

However, depending on a detailed implementation of the measurement chamber and the mentioned mutual arrangement, said light ray may be subject to one or more reflections from the reflector, wherein the reflector may comprise one or more reflector components that may or may not be connected to each other.

The reflector is arranged in the measurement chamber such that light being emitted by the emitter unit in the emission direction is reflected by the reflector and subsequently hits the photosensitive element.

In some implementations, the reflector is represented by one or more components, in particular housing components, of the measurement chamber. In alternative implementations, the reflector comprises one or more mirrors or plastic components arranged in the measurement chamber. The plastic components may for example be black plastic components, in particular if the light of the first pulse is infrared light. For example, plastic material may be used that appears black for the human eye may feature a substantial reflectivity for infrared light, for example approximately 20% for example for a wavelength range around 900 nm.

The measurement chamber may for example serve for generating a dark or shaded measurement environment, in particular may be optically closed. In this way, measurement errors due to ambient light may be reduced.

According to some implementations, the medium present in the measurement chamber is air.

According to some implementations, the medium present in the measurement chamber is a liquid, for example water or another liquid solvent or liquid substance.

The emitter unit may for example comprise a first emitter configured to emit the first pulse. The emission direction is then given by a specified emission direction of the first emitter. In some implementations, the first emitter comprises a laser, for example a laser diode, a vertical-cavity surface-emitting laser, VCSEL, an edge-emitting semiconductor laser or another laser.

Using a laser may have the advantage that spectral shifts of light due to an interaction of the light with contamination, for example on the reflector, may be negligible. Furthermore, using a laser may result in a unique emission direction of the first emitter. Consequently, paths for a light ray being emitted by the first emitter, reflected from the reflector and detected by the photosensitive element may all have the same or substantially the same path length.

Above and in the following, any mentioned difference between points in time corresponds to an absolute value of the difference between points in time.

In some implementations, the described steps of emitting the first pulse and detecting the first reflected fractions are comprised by a measurement cycle. The measurement cycle may be repeated several times in a cyclic manner and the amount of particles may be determined depending on the detection during the respective first time windows of the several measurement cycles. Consequently, the measurement accuracy may be further increased.

The first pulse may for example have a pulse length in the order of several nanoseconds, tens of nanoseconds or hundreds of nanoseconds. One of the measurement cycles may for example have a period in the order of microseconds, tens of microseconds or hundreds of microseconds.

The photosensitive element is configured for time-resolved light detection, in particular for high-speed time-resolved light detection. In some implementations, the photosensitive element comprises a high-speed photon detecting element.

According to some implementations, the photosensitive element comprises one or more avalanche photodiodes, APDs, for example one or more arrays of APDs. In some implementations, the photosensitive element comprises one or more single-photon avalanche diodes, SPADs, for example one or more arrays of SPADs.

According to some implementations, determining the amount of particles depending on the detection during the first time window includes counting a number of light reflections impinging on photosensitive element during the first time window.

In this way, it can be determined how many reflections per time unit occur during the first time window due to reflections from the particles in the medium. The particle measurement signal may then comprise histogram data representing the counts, in particular corresponding to the several measurement cycles. Consequently, the amount of particles may be computed based on the counted number of light reflections impinging on the photosensitive element during the first time window.

According to some implementations, a starting time of the first time window is equal to or later than the starting time of the first pulse, in particular is synchronized with the starting time of the first pulse.

According to some implementations, the photosensitive element and the emitter unit are comprised by a sensor device. The sensor device may comprise a carrier on which the emitter unit and the photosensitive element are mounted. In particular, the photosensitive element and the emitter unit may be arranged on a common plane given by a surface of the carrier. The sensor device may further comprise a cover or an encasement, in particular an optically transparent or translucent cover or encasement, the cover or encasement covering the emitter unit and the photosensitive element.

In such implementations, one or more optical crosstalk paths between the emitter unit and the photosensitive element may exist. The one or more optical crosstalk paths may correspond to paths for light rays being emitted by the emitter unit, for example the first emitter, being reflected by the cover or encasement or by residues or contamination on the cover or encasement and reaching the photosensitive element. Light rays propagating along one of the optical crosstalk paths may for example not leave the sensor device or not propagate beyond the contamination on the cover or encasement. Therefore, such light rays may for example not be reflected by the particles in the medium.

Implementations where the starting time of the first time window is later than the starting time of the first pulse may have the advantage that no or a reduced amount of light reflections corresponding to the optical crosstalk paths may be detected by the photosensitive element during the first time window, which may further increase the measurement accuracy.

In some implementations, a difference between the end time of the first pulse and the starting time of the first time window is greater than a TOF for light propagating along the one or more optical crosstalk paths. Then, an influence of optical crosstalk on the first reflected fractions may for example be reduced or avoided.

According to some implementations, the method further comprises detecting during one or more further time windows further reflected fractions of the first pulse. The method further comprises determining a first compensation factor depending on the detection during the one or more further time windows. Therein, the amount of particles is determined depending further on the first compensation factor.

In such implementations, determining the amount of particles in the medium may for example comprise determining an estimated amount of particles from the first reflections detected during the first time window and correcting the estimated amount of particles using the first compensation factor.

The further reflected fractions of the first pulse may for example be subject to light absorption by the contamination of the measurement chamber, in particular the reflector, and/or the contamination of the cover or encasement. Consequently, the first compensation factor may include information about said light absorption and the respective contaminations. Furthermore, the first reflected fractions detected during the first time window may also be subject to light absorption by the contamination of the cover or encasement.

It may for example be assumed that the contamination of the cover or encasement and the contamination of the measurement chamber, in particular the reflector, are equal or similar. In particular, an effect of the contamination of the reflector on the first pulse may be assumed to be equal or similar to an effect of the contamination of the cover or encasement on the first pulse. Then, it follows that by correcting the estimated amount of particles using the first compensation factor, an effect of the light absorption by the contamination of the cover or encasement on the determined amount of particles in the medium may be reduced or removed. Therefore, the measurement accuracy and a corresponding longtime reliability of a sensor system using a method according to the improved concept may be further improved.

According to some implementations, determining the first compensation factor comprises comparing at least one compensation measurement value or compensation measurement signal depending on the detection during the one or more further time windows to at least one predetermined first reference value.

The at least one first reference value is for example determined by means of at least one respective reference measurement. Therein, it is ensured that during the at least one reference measurement there is no or a negligible contamination of the measurement chamber, in particular the reflector, and the cover or encasement. For example, the at least one reference measurement may be carried out during or directly after a manufacturing of the sensor system utilizing the method according to the improved concept. The at least one first reference value is for example stored in a memory of the sensor system.

According to some implementations, the one or more further time windows comprise a second time window after the first time window. The method comprises detecting during the second time window second reflect fractions of the first pulse by the photosensitive element. The first compensation factor is determined depending on the detection during the second time window.

According to some implementations, determining the first compensation factor includes counting a number of light reflections impinging on the photosensitive element during the second time window.

According to some implementations, the TOF for light propagating along the path with minimum length is greater than a difference between the end time of the first pulse and a starting time of the second time window and is smaller than a difference between the starting time of the first pulse and an end time of the second time window.

Thus, at least a part of light of the first pulse being reflected from the reflector may reach the photosensitive element during the second time window. Consequently, the second reflected fractions of light detected during the second time window are for example subject to reflections from the measurement chamber, in particular the reflector, and therefore may be subject to absorption by the contamination of the measurement chamber, in particular the reflector. In addition, the second reflected fractions may be subject to light absorption by the contamination of the cover or encasement. Thus, the first compensation factor may be used to correct the estimated amount of particles.

The at least one first reference value may comprise a reference value for the second time window. The reference value for the second time window is determined by means of a reference measurement for the second time window, where it is ensured that there is no or a negligible contamination of the measurement chamber and the cover or encasement. Determining the first compensation factor may include comparing a compensation measurement value or compensation measurement signal depending on the detection during the second time window to the reference value for the second time window.

According to some implementations, the TOF for light propagating along the path with minimum length is greater than a difference between the starting time of the first pulse and a starting time of the second time window and/or is smaller than a difference between the end time of the first pulse and an end time of the second time window.

In such implementations, more, for example all or essentially all, parts of light of the first pulse being reflected from the reflector may reach the photosensitive element during the second time window, which may increase accuracy of the first compensation factor.

According to some implementations, the one or more further time windows comprise a third time window before the first time window. The method comprises detecting during the third time window third reflected fractions of the first pulse by the photosensitive element. The first compensation factor is determined depending on the detection during the third time window.

According to some implementations, the determining the first compensation factor includes counting a number of light reflections impinging on the photosensitive element during the third time window.

According to some implementations, a TOF for light propagating along an optical crosstalk path between the emitter unit, in particular the first emitter, and the photosensitive element is greater than a difference between the end time of the first pulse and a starting time of the third time window and is smaller than a difference between the starting time of the first pulse and an end time of the third time window.

Thus, at least a part of light of the first pulse being reflected from the contamination of the cover or encasement may reach the photosensitive element during the third time window. The more contaminated the cover or encasement is, the more light of the first pulse may be reflected or scattered by the contamination on the cover or encasement and the more optical crosstalk will result. Thus, the third reflected fractions of light detected during the third time window depend on the contamination on the cover or encasement. Therefore, the first compensation factor may be used to correct the estimated amount of particles.

The at least one first reference value may comprise a reference value for the third time window, in particular a reference value for optical crosstalk. The reference value for the third time window is for example determined by means of an optical crosstalk reference measurement, where it is ensured that there is no or a negligible contamination of the cover or encasement. Determining the first compensation factor may include comparing a compensation measurement value or a compensation measurement signal depending on the detection during the third time window to the reference value for the third time window.

According to some implementations, the TOF for light propagating along the optical crosstalk path is greater than a difference between the starting time of the first pulse and a starting time of the third time window and/or is smaller than a difference between the end time of the first pulse and an end time of the third time window.

A measurement cycle of the measurement cycles being repeated several times in a cyclic manner may comprise the steps of detecting the further reflected fractions, in particular the second and/or the third reflected fractions. The first compensation factor may be determined depending on the detection during the respective one or more further time windows, in particular during the respective second and/or third time window, of the several measurement cycles.

According to some implementations, the method further comprises emitting by the emitter unit a second pulse of light into the measurement chamber and detecting during a fourth time window reflected fractions of the second pulse. The method further comprises determining a second compensation factor depending on the detection during the fourth time window. Therein, the amount of particles is determined depending further on the second compensation factor.

In such implementations, determining the amount of particles in the medium may for example comprise determining the estimated amount of particles from the first reflections detected during the first time window and correcting the estimated amount of particles using the second compensation factor.

In some implementations, the second pulse is emitted by the first emitter in the emission direction. In alternative implementations, the second pulse is emitted by a second emitter of the emitter unit in a specified further emission direction of the emitter unit, in particular of the second emitter. The further emission direction may be equal to or different from the emission direction.

In some implementations, the second emitter comprises an LED or a laser, for example a laser diode, a vertical-cavity surface-emitting laser, VCSEL, an edge-emitting semiconductor laser or another laser.

According to some implementations, the reflected fractions of the second pulse are detected by the photosensitive element.

According to some implementations, the reflected fractions of the second pulse are detected by a further photosensitive element.

According to some implementations, the further photosensitive element is comprised by the sensor device and mounted on the carrier. The cover or encasement covers the further photosensitive element.

According to some implementations, detecting the reflected fractions of the second pulse includes sensing an intensity of light reaching the further photosensitive element during the fourth time window.

According to some implementations, the further photosensitive element comprises one or more charge coupled devices, CCDs.

According to some implementations, the further photosensitive element comprises one or more photodiodes, for example conventional photodiodes, in particular neither an APD nor a SPAD.

For sensing the intensity of light reaching the further photosensitive element during the fourth time window, the further photosensitive element is not required to be particularly configured for time-resolved light detection, in particular high-speed time-resolved light detection.

According to some implementations, a further path with minimum length for a light ray being emitted by the emitter unit, reflected from the reflector and detected by the further photosensitive element is defined by the further emission direction of the emitter unit, in particular of the first or second emitter, and by a mutual arrangement of the reflector, the emitter unit, in particular the first or second emitter, and the further photosensitive element. A TOF for light propagating along the further path with minimum length is greater than a difference between an end time of the second pulse and a starting time of the fourth time window and is smaller than a difference between the starting time of the second pulse and an end time of the fourth time window.

Consequently, the reflected fractions of light detected during the fourth time window are for example subject to reflections from the measurement chamber, in particular the reflector, and therefore may be subject to absorption by contamination of the measurement chamber, in particular the reflector. In addition, the reflected fractions of the second pulse may be subject to light absorption by the contamination on the cover or encasement. Thus, the second compensation factor may be used to correct the estimated amount of particles.

According to some implementations, the determining of the second compensation factor comprises comparing at least one compensation measurement value or compensation measurement signal depending on the detection during the fourth time window to a predetermined further reference value.

The further reference value is determined by means of a reference measurement, where it is ensured that there is no or a negligible contamination of the measurement chamber and the cover or encasement.

According to some implementations, the TOF for light propagating along the further path with minimum length is greater than a difference between the starting time of the second pulse and a starting time of the fourth time window and/or is smaller than a difference between the end time of the second pulse and an end time of the further time window.

In some implementations, the described steps of emitting the second pulse and detecting the reflected fractions of the second pulse are comprised by a further measurement cycle. The further measurement cycle may be repeated several times in a cyclic manner and the second compensation factor may be determined depending on the detection during the respective fourth time windows of the several further measurement cycles. Consequently, the measurement accuracy may be further increased.

According to some implementations, the sensor device is arranged inside the measurement chamber and connected to the measurement chamber. In some implementations, the sensor device is removable from the measurement chamber. In such implementations, the sensor device may for example be comprised by an electronic device, such as a smartphone, a tablet computer, a smartwatch or the like.

According to some implementations, the method further comprises determining a quality index depending on the first and/or the second compensation factor. The quality index is indicative of the contamination of the cover or encasement and/or of the measurement chamber, in particular the reflector.

Depending on the quality index, an alert signal may be generated for example to signal that a measurement accuracy may lie in an undesired range. In response to the alert signal, a user may for example decide to clean or replace the measurement chamber and/or the sensor device.

In some implementations, an emission intensity of the first and/or the second pulse may be adjusted, for example increased, depending on the quality index and/or the alert signal. In this way, the measurement accuracy may for example be kept sufficiently high for a longer time. Thus, longtime reliability may be further increased.

According to the improved concept, also a sensor system with a measurement chamber for detecting particles in a medium present in the measurement chamber is provided. The system further comprises an emitter unit configured to emit a first pulse of light into the measurement chamber in a specified emission direction of the emitter unit. The system further comprises a photosensitive element configured to detect first reflected fractions of the first pulse during a first time window. The system further comprises a processing unit configured to determine an amount of particles in the medium depending on the detection during the first time window.

A path with minimum length for a light ray being emitted by the emitter unit, reflected from a reflector of the measurement chamber and detected by the photosensitive element is defined by the emission direction and by a mutual arrangement of the reflector, the emitter unit the photosensitive element. A difference between a starting time of the first pulse and an end time of the first time window is smaller than a TOF for light propagating along the path with minimum length.

According to some implementations, the system comprises an integrated circuit, IC, comprising the photosensitive element and the processing unit. According to some implementations, the IC further comprises the emitter unit.

Further implementations of the sensor system according to the improved concept are readily derived by the various implementations of the method according to the improved concept and vice versa. In particular, the processing unit of the sensor system may be configured to carry out or control the various steps comprised by a method according to the improved concept excluding for example such steps that are obviously carried out by another component of the sensor system, such as the emitter unit or the photosensitive element.

In the following, the improved concept is explained in detail with the aid of exemplary implementations by reference to the drawings. Components that are functionally identical or have an identical effect may be denoted by identical references. Identical components and/or components with identical effects may be described only with respect to the figure where they occur first. Their description is not necessarily repeated in subsequent figures.

### BRIEF DESCRIPTION OF THE DRAWINGS

In the drawings,

FIG. 1A shows an exemplary implementation of a sensor system according to the improved concept and aspects of an exemplary implementation of a method according to the improved concept;

FIG. 1B shows a timing diagram according to the improved concept;

FIG. 2 shows a further exemplary implementation of a sensor system according to the improved concept and aspects of a further exemplary implementation of a method according to the improved concept;

FIG. 3 shows a further exemplary implementation of a sensor system according to the improved concept and aspects of a further exemplary implementation of a method according to the improved concept;

FIG. 4 shows timing diagrams of measurement signals of a further exemplary implementation of a sensor system according to the improved concept; and

FIG. 5 shows a block diagram of an exemplary implementation of a sensor device of a sensor system according to the improved concept.

### DETAILED DESCRIPTION

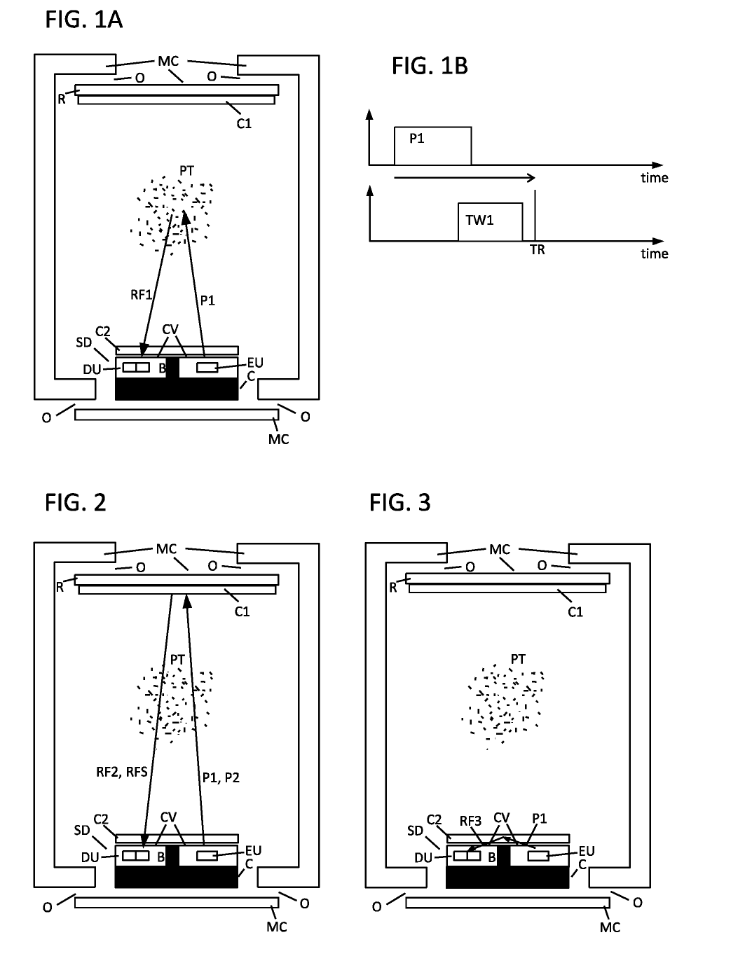

FIG. 1A shows an exemplary implementation of a sensor system according to the improved concept and aspects of an exemplary implementation of a method according to the improved concept.

The sensor system comprises a measurement chamber MC, for example an optically closed measurement chamber MC, and a sensor device SD arranged inside the measurement chamber MC. The measurement chamber MC also comprises a reflector R arranged, for example, on a side of the measurement chamber MC opposite to the sensor device SD.

The sensor device SD comprises for example a carrier C, an emitter unit EU arranged on the carrier C and a detector unit DU arranged on the carrier C. The detector unit DU and the emitter unit EU are for example covered by a cover or encasement CV of the sensor device SD. Optionally, the sensor device SD may comprise a light barrier B arranged on the carrier C between the detector unit DU and the emitter unit EU to block light reaching the detector unit DU from the emitter unit EU directly.

The emitter unit EU comprises an emitter, for example a laser, in particular a VCSEL, configured to emit light, in particular in a pulsed manner, in a predefined emission direction of the emitter. The detector unit DU comprises a photosensitive element, in particular a photosensitive element capable of time-resolved light detection. The photosensitive element may, for example, comprise one or more SPADs, in particular an array of SPADs.

FIG. 1A also shows particles PT present in a medium, for example air or a liquid such as water, within the measurement chamber MC. The particles PT may have entered the measurement chamber MC for example via openings O in the measurement chamber MC. It is highlighted that, although the particles PT are depicted in FIG. 1A as being located in the center of the measurement chamber, they may in reality be distributed, in particular distributed essentially homogenously, within the measurement chamber MC.

FIG. 1A also shows a first contamination C1 located on a surface of the reflector R facing the sensor device SD. Furthermore, a second contamination C2 is shown to be located on top of the sensor device SD, in particular the cover or encasement CV. Further contamination of the measurement chamber, for example on sidewalls of the measurement chamber, may be present but are not shown in FIG. 1A.

Neglecting the presence of the contamination C1, C2 and also the presence of the particles PT, a ray of light emitted by the emitter along the emission direction would reach the reflector R without any reflection or scattering, would undergo a specular reflection from the reflector R and then would reach the photosensitive element again without being reflected or scattered. The described path represents a path with minimum length. A time-of-flight, TOF, for light propagating along the path with minimum length is for example determined by a distance between the sensor device SD and the reflector R, a distance between the emitter and the photosensitive element and the speed of light.

In operation, the emitter is configured to emit a first pulse of light P1 in the emission direction. In the presence of the particles PT, parts of the first pulse P1 are reflected by the particles PT and consequently first reflected fractions RF1 of the first pulse P1 may reach the photosensitive element. The photosensitive element is configured to detect the first reflected fractions RF1 during a first time window TW1 as shown in FIG. 1B, which shows a timing diagram including the first pulse P1 and the first time window TW1. FIG. 1B also shows a reflection time TR corresponding to a point in time when light fractions of the first pulse P1 that propagate along the path with minimum length would reach the photosensitive element.

According to the improved concept, the reflection time TR does not lie within the first time window TW1, in particular lies after the first time window TW1. In particular, a time difference between a starting time of the first pulse P1 and the reflection time TR corresponds to the TOF for light propagating along the path with minimum length, as indicated by a horizontal arrow in FIG. 1B. According to the improved concept, an end time of the first time window TW1 lies before the reflection time TR.

As mentioned above, the photosensitive element may comprise a SPAD or an array of SPADs. Therefore, the photosensitive element may for example be configured to count a number of light reflections impinging on the photosensitive element during the first time window TW1.

The described measurement is, for example, repeated at high frequency, for example with a frequency lying in the kHz range or range of tens of kHz. In each measurement cycle, a first pulse P1 may be emitted by the emitter and first reflected fractions RF1 may be detected by the photosensitive element during a respective first time window TW1 of the measurement cycle. Depending on the counted reflections impinging on the photosensitive element during each of the measurement cycles, for example histogram data may be generated by a processing unit PU (not shown in FIG. 1A) depending on the counted light reflections.

Depending on the detections of the photosensitive element during the first time window TW1, for example during the first time windows TW1 of the repeated measurement cycles, the processing unit PU may determine an amount of particles in the medium, for example based on the histogram data.

An advantage of the described method for particle detection is that the detection of the first reflected fractions RF1 during the first time windows TW1 does not depend on the contamination C1. This is due to the fact that the first reflected fractions RF1 have not been subject to a reflection from the reflector R due to the described timing of the first time window TW1, in particular due to the end time of the first time window TW1 lying before the reflection time TR.

Therefore, the detection of the first reflected fractions RF1 is not subject to effects of light absorption by the first contamination C1. Therefore, accuracy of the measurement, in particular accuracy of the determined amount of particles, may be increased.

In situations, where the second contamination C2 is present on the cover or encasement CV, the measurement explained with respect to FIGS. 1A and 1B may have an error due to light absorption by the second contamination C2.

Further implementations of the method according to the improved concept may reduce also the error due to the absorption by the second contamination C2 as explained with respect to FIGS. 2 and 3.

FIG. 2 shows a further exemplary implementation of a sensor system according to the improved concept and further aspects of an exemplary implementation of a method according to the improved concept. For example, the sensor system of FIG. 2 may be based on or may be equal to the sensor system of FIG. 1A.

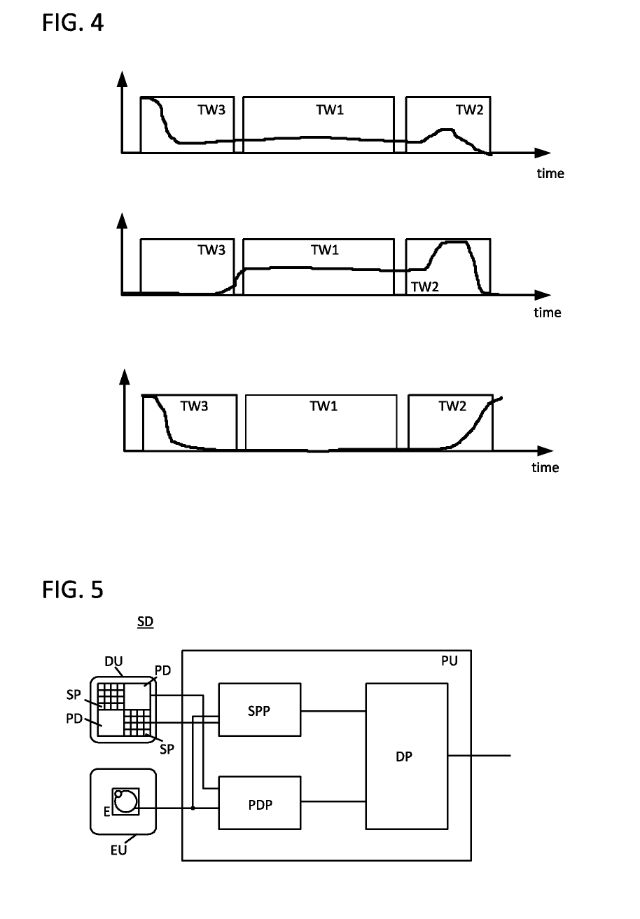

FIG. 2 shows a situation where the first pulse P1 is emitted by the emitter and second reflected fractions RF2 of the first pulse P1 are detected by the photosensitive element during a second time window TW2. The second time window TW2 lies after the first time window TW1 as shown in FIG. 4. In particular, the reflection time TR may lie in the second time window TW2. Therefore, the reflected fractions RF2 of the first pulse P1 are subject to light absorption by the second contamination C2 and by the first contamination C1. Therefore, the detection of the second reflected fractions RF2 during the second time window TW2 by the photosensitive element may be used to calculate a first compensation factor. By means of the first compensation factor and the detection of the first reflected fractions RF1 during the first time window TW1, the amount of particles may be determined with an improved accuracy.

For example, the first compensation factor may be calculated depending of a reference value for light detection during the second time window TW2. For example, a reference measurement may be carried out in a situation where the first and the second contamination C1, C2 and also the particles PT are not present, for example directly after manufacturing of the sensor system.

Denoting by MV a measurement value for the detection of the second reflected fractions RF2 in the presence of the contaminations C1, C2 and the particles PT and denoting by RV a reference value for the detection during the second time window TW2 without the contaminations C1, C2 and without the particles PT, the first compensation factor CMP may, for example, be calculated according to the formula

CMP=1−(1−MV/RV)/2 (1)

The first compensation factor CMP may for example be considered to represent a transmission-of-optical-path, TOP, value. The TOP value is for example a measure for the amount of light propagating along the path with minimum length being transmitted compared to the respective amount of light being absorbed.

Denoting by EP an estimated amount of particles determined based on the detection of the first reflected fractions RF1 as explained with respect to FIG. 1A, an improved value IP for the amount of particles may then be calculated, for example based on the formula

IP=EP/CMP (2)

The detection of the second reflected fractions RF2 may be repeated for each measurement cycle. The calculation of the first compensation factor and the improved amount of particles may then be carried out based on the measurement result from the different measurement cycles.

It is highlighted that the calculation of the improved value IP for the amount of particles according to formulas (1) and (2) represents only an example calculation. In particular, other suitable formulas may be used for calculating the first compensation factor and/or the improved value for the amount of particles based on the first compensation factor. For example, a coefficient or lookup table, depending for example on a surface of the reflector R, could alternatively or additionally be used to improve the accuracy of the calculation of the amount of particles.

During the operation time or lifetime of the sensor system, the first compensation factor or the TOP value may become lower because the contaminations C1, C2 may increase. For example to check whether the TOP becomes too low for reliable operation, a level of quality or quality index could be calculated based on the first compensation factor. A user of the sensor system could, for example, replace or clean the sensor system depending on the quality index. Alternatively or in addition, an emission intensity of light emitted by the emitter may be increased depending on the quality index. In this way, a reliable operation may be ensured for a longer time.

In further implementations the determination of the amount of particles in the medium may be further improved by removing or avoiding an effect of the particles PT on the first compensation factor. This could, for example, be done to first order with a linear estimation and/or for example using an additional lookup table.

In some implementations the sensor device SD comprises a further photosensitive element, for example a photodiode, in particular a conventional photodiode. In particular, the further photosensitive element does not necessarily comprise a SPAD or an array of SPADs. In such implementations, a second compensation factor may be determined instead of or in addition to the first compensation factor.

The emitter unit, for example the emitter or a further emitter, may be configured to emit a second pulse of light P2, for example in a further emission direction. The further emission direction may be equal to the emission direction of the emitter, in particular if the second pulse P2 is emitted by the emitter. In implementations where the second pulse P2 is emitted by the further emitter, the further emission direction may be equal or different from the emission direction of the emitter.

The further photosensitive element is configured to detect reflected fractions RFS of the second pulse P2 during a further time window. The detection of the reflected fractions RFS of the second pulse P2 includes, for example, sensing an intensity of light reaching the further photosensitive element during the further time window. In particular, a counting of reflections impinging on the further photosensitive element during the further time window is not necessary.

A timing of the further time window may be such that the reflected fractions RFS of the second pulse P2 may comprise reflections from the reflector R. In particular, a further reflection time corresponds to a point in time when light fractions of the second pulse P2 that propagate along a further path with minimum length would reach the photosensitive element. Therein, the further path with minimum length is a path for a light ray being emitted by the emitter unit, in particular along the further emission direction, reflected from the reflector R and detected by the further photosensitive element. The further reflection time may lie within the further time window.

The further path with minimum length may be equal to the path with minimum length or different from that, depending on the further emission direction and a position of the further photosensitive element with respect to the emitter unit and the reflector R.

As for the emission of the first pulse P1 and the detection of the first and/or second reflected fractions RF1, RF2, also an emission of the second pulse P2 and the detection of the reflected fractions RFS of the second pulse P2 may be repeated in a cyclic manner.

While the first pulses may be in particular high speed pulses with pulse lengths in the order of nanoseconds or tens of nanoseconds, the second pulses P2 may, for example, be slower, for example in the range of microseconds.

A second compensation factor depending on the detection of the reflected fractions RFS of the second pulse P2 may for example by calculated analogously as described above with respect to the first compensation factor.

In some implementations, a synchronous demodulator may be used, which could have the advantage that an effect of ambient light may be reduced.

FIG. 3 shows a further exemplary implementation of a sensor system according to the improved concept and further aspects of an exemplary implementation of a method according to the improved concept. For example, the sensor system of FIG. 3 may be based on or may be equal to the sensor system of FIG. 1A.

FIG. 3 shows third reflected fractions RF3 of the first pulse P1. The third reflected fractions RF3 are subject to a reflection from the cover or encasement CV and/or from the second contamination C2 being present on the cover or encasement CV. In this way, by being reflected from the second contamination C2, the third reflected fractions RF3 may reach the photosensitive element without having left the sensor device SD. This phenomenon may be denoted as optical crosstalk.

Alternatively or in addition to the detection of the second reflected fractions RF2 of the first pulse P1 and/or the reflected fractions RFS of the second pulse P2 as described with respect to FIG. 2, the third reflected fractions RF3 of the first pulse P1 may be detected by the photosensitive element during a third time window TW3 as shown in FIG. 4. The third time window TW3 lies before the first time window TW1. In particular, a TOF for light propagating along an optical crosstalk path between the emitter and the photosensitive element is greater than a difference between an end time of the first pulse and a starting time of the third time window and is smaller than a difference between the starting time of the first pulse and an end time of the third time window.

A crosstalk compensation factor may for example be determined depending on the detection of the third reflected fractions RF3. In particular, the higher a measurement signal due to the reflected fractions RF3 is, the more contamination C2 is present. Consequently, by correcting the amount of particles determined based on the detection of the first reflected fractions RF1 or the improved amount of particles calculated using the first and/or the second compensation factor using the crosstalk compensation factor, the measurement accuracy may be further improved.

FIG. 4 shows timing diagrams of measurement signals of a further exemplary implementation of a sensor system according to the improved concept. The sensor system may for example be a sensor system as described with respect to FIGS. 1A, 1B, 2 and 3.

In each of the panels of FIG. 4, the first, the second and the third time window TW1, TW2, TW3 are shown. Time is shown on the x-axes. On the y-axes a measurement signal generated by the processing unit PU based on the detections of the photosensitive element during the first, the second and the third time window TW1, TW2, TW3 is shown. The measurement signal may for example correspond to the histogram data generated based on the detection of the SPAD or SPAD array of the detector unit DU.

The top panel of FIG. 4 corresponds to a situation where the first and the second contamination C1, C2 as well as the particles PT are present in the measurement chamber MC. During the third time window TW3 the measurement has a high value due to optical crosstalk as described with respect to FIG. 3. During the first time window TW1 the measurement signal has an intermediate value due to the detection of the first reflected fractions RF1. During the second time window TW2 the measurement signal is again increased with respect to the first time window TW1 due to the detection of the reflected fractions RF2 being reflected from the reflector R.

The middle panel of FIG. 2 corresponds to a situation where the particles PT are present in the measurement chamber, but the first and the second contaminations C1 and C2 are not present. This may, for example, correspond to a situation shortly after manufacturing of the sensor system. In this case, the measurement signal is low or zero in the third time window TW3 since an amount of optical crosstalk is reduced because the second contamination C2 is not present. The measurement signal is increased in the first time window TW1 compared to the top panel of FIG. 4 since the first reflected fractions RF1 are not subject to absorption by the second contamination C2. The measurement signal is also increased in the second time window TW2 with respect to the top panel of FIG. 4 since the second reflected fractions RF2 are neither subject to light absorption by the first contamination C1 nor by the second contamination C2.

The lower panel of FIG. 4 corresponds to a situation, where the first and the second contaminations C1, C2 are present, but no particles PT or a negligible amount of particles PT is present in the measurement chamber MC. In this case, the crosstalk reflected in the measurement signal during the third time window TW3 has a similar value as in the top panel of FIG. 4. Compared to the top and the middle panels of FIG. 4, the measurement signal is strongly reduced during the first time window in the bottom panel of FIG. 4. This is due to the fact that there are no or essentially no reflections from the particles PT and therefore, during the first time window TW1, no or a negligible amount of first reflected fractions RF1 is reaching the photosensitive unit. In the second time window TW2, the measurement signal is again increased with respect to the first time window TW1 due to the detection of the second reflected fractions RF2 being reflected from the reflector R.

FIG. 5 shows a block diagram of an exemplary implementation of a sensor device SD of a sensor system according to the improved concept.

The sensor device SD comprises a processing unit PU, a detector unit DU and an emitter unit EU. The emitter unit EU comprises an emitter E, for example a laser, in particular a VCSEL or an edge emitter laser. The detector unit DU comprises a photosensitive element including for example an array of SPADs SP. Optionally, the detector unit DU comprises a further photosensitive element being including, for example one or more photodiodes PD, in particular conventional photodiodes.

The processing unit PU comprises, for example, a data processor DP, a SPAD processor SPP, and optionally a photodiode processor PDP. The SPAD array SP is connected to the SPAD processor SPP, while the optional photodiode PD is, for example, connected to the optional photodiode processor PDP. Furthermore, the emitter E is connected to the SPAD processor SPP and optionally to the optional photodiode processor PDP. The SPAD processor SPP, and optionally the photodiode processor PDP, are connected to the data processor DP. The operation of the sensor device SD and the sensor system is as has been explained with respect to FIGS. 1A to 4.

Based on the detection of the first reflected fractions RF1 during the first time window TW1, and optionally based on the second reflected fractions RF2 detected during the second time window TW2 and/or the third reflected fractions RF3 during the third time window TW3, the SPAD processor SPP is, for example, configured to generate histogram data based on the counted reflections impinging on the SPAD array SP during the respective time windows. Based on the respective histogram data, the data processor DP is for example configured to compute the amount of particles in the medium, the first compensation factor, the crosstalk compensation factor and/or the improved amount of particles based on the estimated amount of particles and the respective compensation factors.

Optionally, the photodiode processor PDP is configured to generate a photodiode signal depending on a detected intensity of the reflected fractions RFS of the second pulse P2 during the further time window by the one or more photodiodes PD. Based on the photodiode signal, the data processor DP is for example configured to determine the second compensation factor and to correct the amount of particles in the medium as described with respect to FIG. 2.

In the description with respect to FIGS. 1A to 5, the first, second and third reflected fractions RF1, RF2, RF3 were considered to be reflected fractions of the first pulse P1. However, the measurements of the different reflected fractions can in principle also be carried out with respect to first pulses P1 from different measurement cycles.

Furthermore, in the examples of FIGS. 1A, 2 and 3, the detector unit and the emitter unit DU, EU are for example both contained by a single chip module of the sensor device SD. In some implementations, the detector unit DU, the emitter unit, EU and the processing unit PU may, for example, be comprised by the same IC. In alternative implementations, the emitter EU may be implemented separately from the IC with the detector unit DU. In such implementations, the emitter unit EU may be comprised by the same chip module as the IC comprising the detector unit DU and the processing unit PU or may be implemented in a separate chip module.

In alternative implementations, the sensor system may comprise additional photosensitive elements, for example implemented in the detector unit DU or in additional detector units, which are not shown in FIGS. 1A to 5. The photosensitive element, the further photosensitive element and/or the additional photosensitive elements may, for example, by equipped with different optical filters for the detection of light with different wavelengths. In this way, for example, different particle sizes, different particle types or different types of the contaminations C1, C2 may be detected by means of the different photosensitive elements. The described implementations may be readily adapted to account for the additional photosensitive elements.

Analogously, in alternative implementations, the sensor system may comprise alternatively or in addition to the additional photosensitive elements, additional emitter units or emitters that are configured to emit light with different wavelengths. Also in this way different particle sizes, different particle types or different types of the contaminations C1, C2 may be distinguished.

In implementations where the medium is air, the sensor system or method according to the improved concept may for example be used to determine a degree of air pollution or air contamination or a degree of air quality, respectively.

In implementations where the medium is a liquid, for example water or another liquid solvent or liquid substance, the sensor system or method according to the improved concept may for example be used to determine a degree of liquid or water contamination or a degree of liquid or water quality, respectively. Such implementations may for example be used in a washing machine, a dishwasher or a process engineering system, in particular a physical, chemical or biological engineering system.

1. A method for detecting particles in a medium present in a measurement chamber, the method comprising
emitting by an emitter unit a first pulse of light into the measurement chamber in a specified emission direction of the emitter unit;
detecting by a photosensitive element first reflected fractions of the first pulse during a first time window; and
determining an amount of particles in the medium depending on the detection during the first time window;
herein a path with minimum length for a light ray being emitted by the emitter unit, reflected from a reflector of the measurement chamber and detected by the photosensitive element is defined by the emission direction and by a mutual arrangement of the reflector, the emitter unit and the photosensitive element; and
wherein a difference between a starting time of the first pulse and an end time of the first time window is smaller than a time-of-flight for light propagating along the path with minimum length.

2. The method according to claim 1, wherein the method further comprises
detecting during one or more further time windows
reflected fractions of a second pulse of light emitted by the emitter unit into the measurement chamber; and/or
further reflected fractions of the first pulse, the reflected fractions and/or further reflected fractions being subject to light absorption by a contamination of the measurement chamber, in particular the reflector, and/or a contamination of the cover or encasement; and
determining at least one compensation factor depending on the detection during the one or more further time windows, wherein the amount of particles is determined further depending on the one or more compensation factors.

3. The method according to claim 2, wherein the determining of the at least one compensation factor comprises comparing at least one measurement value depending on the detection during the one or more further time windows to at least one predetermined reference value.

4. The method according to claim 2, wherein
the one or more further time windows comprise a second time window after the first time window;
the method comprises detecting during the second time window second reflected fractions of the first pulse by the photosensitive element; and
the at least one compensation factor is determined depending on the detection during the second time window.

5. The method according to claim 4, wherein the time-of-flight for light propagating along the path with minimum length
is greater than a difference between an end time of the first pulse and a starting time of the second time window; and
is smaller than a difference between the starting time of the first pulse and an end time of the second time window.

6. The method according to claim 2, wherein
the one or more further time windows comprise a third time window before the first time window;
the method comprises detecting during the third time window third reflected fractions of the first pulse by the photosensitive element; and
the at least one compensation factor is determined depending on the detection during the third time window.

7. The method according to claim 6, wherein a time-of-flight for light propagating along an optical crosstalk path between the emitter unit and the photosensitive element
is greater than a difference between an end time of the first pulse and a starting time of the third time window; and
is smaller than a difference between the starting time of the first pulse and an end time of the third time window.

8. The method according to claim 2, wherein
the one or more further time windows comprise a fourth time window;
the method comprises detecting during the fourth time window the reflected fractions of the second pulse by a further photosensitive element; and
the at least one compensation factor is determined depending on the detection during the fourth time window.

9. The method according to claim 8, wherein
a further path with minimum length for a light ray being emitted by the emitter unit, reflected from the reflector and detected by the further photosensitive element is defined by a specified further emission direction of the emitter unit and by a mutual arrangement of the reflector, the emitter unit and the further photosensitive element;
a time-of-flight for light propagating along the further path with minimum length is greater than a difference between an end time of the second pulse and a starting time of the fourth time window; and
the time-of-flight for light propagating along the further path with minimum length is smaller than a difference between the starting time of the second pulse and an end time of the fourth time window.

10. The method according to claim 8, wherein the detecting the reflected fractions of the second pulse includes sensing an intensity of light reaching the further photosensitive element during the fourth time window.

11. The method according to claim 2, further comprising determining a quality index depending on the at least one compensation factor, the quality index being indicative of a contamination of the emitter unit, the photosensitive element and/or the measurement chamber.

12. The method according to claim 1, wherein the determining the amount of particles includes counting a number of light reflections impinging on the photosensitive element during the first time window.

13. The method according to claim 1, wherein the photosensitive element comprises one or more avalanche photodiodes and/or one or more single-photon avalanche diodes.

14. A sensor system for detecting particles in a medium present in a measurement chamber of the system, the system further comprising
an emitter unit configured to emit a first pulse of light into the measurement chamber in a specified emission direction of the emitter unit;
a photosensitive element configured to detect first reflected fractions (RF1) of the first pulse during a first time window; and
a processing unit configured to determine an amount of particles in the medium depending on the detection during the first time window;
wherein
a path with minimum length for a light ray being emitted by the emitter unit, reflected from a reflector of the measurement chamber and detected by the photosensitive element is defined by the emission direction and by a mutual arrangement of the reflector, the emitter unit and the photosensitive element; and
a difference between a starting time of the first pulse and an end time of the first time window is smaller than a time-of-flight for light propagating along the path with minimum length.

15. The system according to claim 14, the system comprising an integrated circuit comprising the photosensitive element and the processing unit.
